(19) United States
(12) Patent Application Publication
(10) Pub. No.: US 2007/0085860 A1
(43) Pub. Date: Apr. 19, 2007

(54) Technique for improving the readability of graphics on a display

(75) Inventor: John M. Schmitt, Glendale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/250,074

(22) Filed: Oct. 13, 2005

(51) Int. Cl. G09G 5/02; G09G 5/00

(52) U.S. Cl. 345/629; 345/592

(57) ABSTRACT

A layered graphical display is provided. The layered graphical display comprises a plurality of graphics, wherein one or more of said plurality of graphics is overlaid onto one or more other graphics of said plurality of graphics. The layered graphical display also comprises a shaded region behind each of said one or more overlying graphics which distinguishes the one or more overlying graphics from the one or more other graphics.

### TECHNICAL FIELD

The present invention generally relates to graphical displays and, in particular, to improving the readability of graphics displayed.

### BACKGROUND

Over the years, graphical displays have become more versatile. Graphical displays are now used in a variety of different applications including displays in vehicles, such as airplanes and automobiles, and displays in personal electronic devices, such as cellular phones and notebook computers. This versatility is due in large part to the development and improvement of new technology such as liquid crystal displays (LCD). For example, a modem active matrix liquid crystal display (AMLCD) can provide similar performance to a full-color cathode ray tube (CRT) display while requiring less power and occupying significantly less space than a CRT display.

Often, these displays will contain various graphics layered on top of each other. In aircraft, for example, flight information may be overlaid on a background display of the terrain and sky. Similarly, displays in automobiles may overlay speedometer or fuel indicator graphics on a background display of the road or a map. Typically the visibility of the displays is adversely affected by bright ambient light such as sunlight. This is particularly true of LCD displays. It is also often difficult in bright ambient light to distinguish between the various graphics overlaid on the same display. The difficulty in distinguishing graphics not only reduces the utility of the display but it also creates serious risks of accident when the operator of a vehicle is unable to distinguish pertinent information from less important information in an emergency situation. Many methods have been developed to attempt to address the visibility of the display in bright ambient light. Yet, these methods are addressed generally only at increasing the visibility of the display as a whole. These methods do not address the specific problem of improving a viewer's ability in bright ambient light to distinguish between various graphics overlaid on the same display.

For the reasons stated above, and for other reasons stated below which will become apparent to those skilled in the art upon reading and understanding the present specification, there is a need in the art for a display which improves the readability of graphics on a display enabling the viewer to easily distinguish between various graphics overlaid on the same display particularly in the presence of bright ambient light.

### SUMMARY

Embodiments of the present invention solve problems with the readability of graphics on a display enabling viewers to easily distinguish between various graphics overlaid on the same display.

In one embodiment, a layered graphical display is provided. The layered graphical display comprises a plurality of graphics, wherein one or more of said plurality of graphics is overlaid onto one or more other graphics of said plurality of graphics. The layered graphical display also comprises a shaded region behind each of said one or more overlying graphics which distinguishes the one or more overlying graphics from the one or more other graphics.

In another embodiment, layered graphical display is provided. The layered graphical display comprises means for displaying two or more graphics on a display element, wherein at least one of said two or more graphics is overlaid onto at least one other graphic of said two or more graphics. The layered graphical display also comprises means for calculating a shaded region for display on a display element, means for calculating an outline for display on a display element and means for displaying said calculated shaded region behind the at least one graphic overlaid onto at least one other graphic, said shaded region distinguishing the at least one overlaid graphic from the at least one other graphic. Additionally, the layered graphical display comprises means for displaying said calculated outline around said shaded region and the at least one graphic overlaid onto at least one other graphic.

In another embodiment, a method for improving the readability of graphics on a display is provided. The method comprises displaying a plurality of graphics on a display, wherein one or more graphics of said plurality of graphics is overlaid onto one or more other graphics of said plurality of graphics. The method also comprises selecting which of the one or more overlying graphics to shade with a shaded region, selecting which of the one or more overlying graphics to outline, rendering the shaded region for the selected overlying graphics, and rendering the outline for the selected overlying graphics.

In another embodiment, a computer readable medium having computer-executable instructions for performing a method for improving the readability of graphics on a display is provided. The method comprises selecting a first group of one or more graphics on a display to shade with a shaded region for each graphic selected and selecting a second group of one or more graphics on a display to substantially surround with an outline for each graphic selected. The method also comprises selecting a transparency level and a color for the one or more shaded regions and selecting a transparency level and a color for the one or more outlines. The method further comprises rendering the shaded region with the selected transparency level and color for each graphic in the first group, and rendering the outline with the selected transparency level and color for each graphic in the second group.

### DRAWINGS

FIG. 1A is a graphic to be displayed on a display element.

FIG. 1B shows other graphics to be displayed on a display element.

FIG. 1C is an image of a conventional graphical display.

FIG. 2 is an image of a graphical display according to one embodiment of the present invention.

FIG. 3 is an image of a graphical display according to another embodiment of the present invention.

FIG. 4 is an image of a graphical display according to another embodiment of the present invention.

FIG. 5 is a flow chart showing a method of improving the readability of overlaid graphics according to one embodiment of the present invention.

FIG. 6 is a block diagram of a graphical display system according to one embodiment of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. Furthermore, it will be understood by one of skill in the art that although the specific embodiments illustrated below are directed at aircraft for purposes of explanation, the method and apparatus may be used in various embodiments employing various types of displays, such as displays in space craft, automobiles, and hand held electronic devices, etc. Moreover, the present invention is suitable for use on CRT, LCD or any other existing or later developed display technology. It should also be understood that the exemplary method illustrated may include additional or fewer steps or may be performed in the context of a larger processing scheme. Furthermore, the method presented in the drawing figures or the specification is not to be construed as limiting the order in which the individual steps may be performed. The following detailed description is, therefore, not to be taken in a limiting sense.

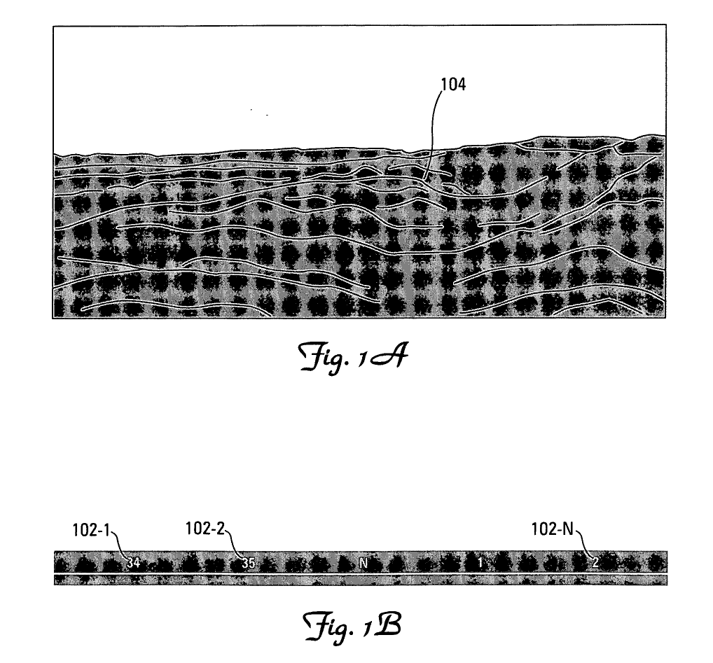

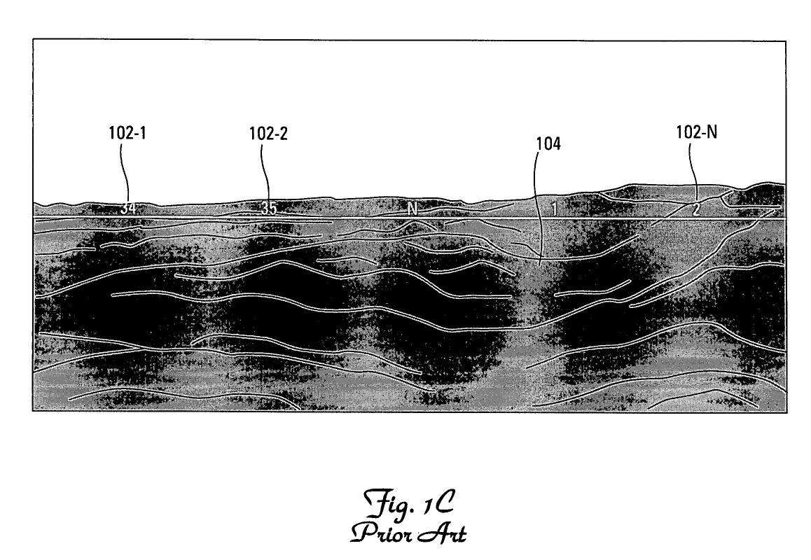

FIG 1A is a graphic to be displayed on a display element. In this embodiment, graphic 104 represents terrain and sky for display on an aircraft display element. In other embodiments, other appropriate graphics, such as road images, maps, personal photos, etc. are used depending the application and display element. FIG. 1B shows other graphics for display on a display element. In this embodiment, graphics 102-1 . . . 102-N represent directional headings for display on an aircraft display element. In other embodiments, other appropriate graphics, such as speedometer readings, fuel gauges, phone numbers, etc. are used depending on the application and display element.

FIG. 1C is an image of a conventional graphical display which combines the graphics from FIGS. 1A and 1B. As shown in FIG. 1C, graphics 102-1 . . . 102-N are overlaid on graphic 104. It is difficult in FIG. 1C to distinguish some of graphics 102-1 . . . 102-N from graphic 104. The difficulty in distinguishing graphics is increased as the ambient light becomes brighter. Current attempts at improving the visibility of displays are focused on improving visibility of the display as a whole. They do not address this specific difficulty of distinguishing overlaid graphics on the same display with the advantages of the embodiments of the present invention.

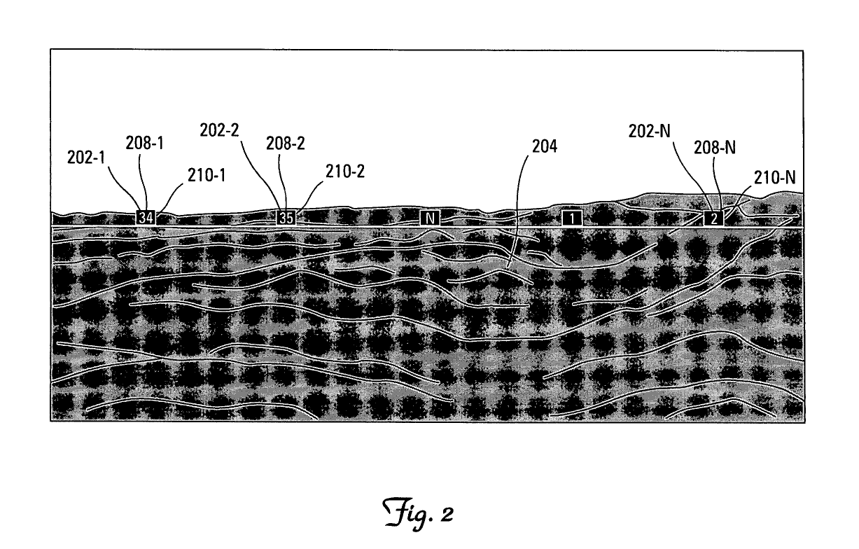

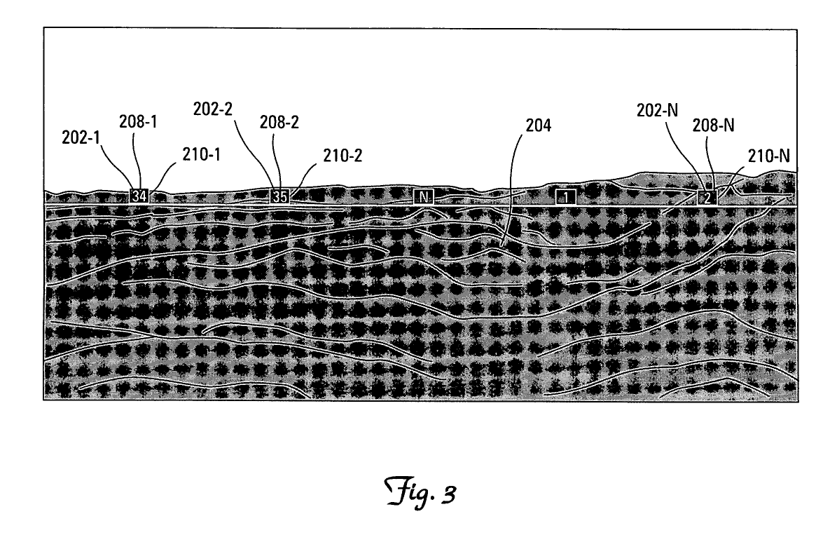

FIGS. 2-4 are images of a graphical display according to embodiments of the present invention. For purposes of explanation, the same graphics from FIGS. 1A and 1B are used in FIGS. 2-4. In these embodiments a display for use in aircraft is used. However, it will be understood by one of skill in the art that, in other embodiments, displays suitable for handheld electronic devices, automobiles, etc. employ the present invention to improve the ability to distinguish between graphics overlaid on the same display.

In FIG. 2, graphics 202-1 . . . 202-N are shaded with shaded region 208-1 . . .208-N and outlined by outline 210-1 . . . 210-N, respectively. In other embodiments, graphics 202-1 . . . 202-N are only shaded by shaded region 208-1 . . . 208-N or, alternatively, only outlined by outline 210-1 . . . 210-N, respectively. In some embodiments, the transparency level of shaded region 208-1 . . . 208-N and the transparency level of outline 208-1 . . . 208-N are adjustable from completely transparent to completely opaque.

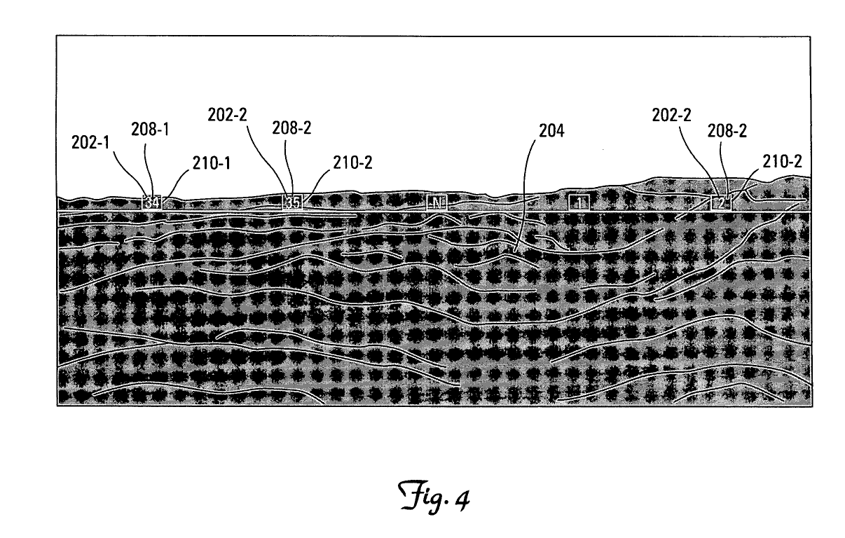

The embodiment in FIG. 2 sets the transparency level of both shaded region 208-1 . . . 208-N and outline 210-1 . . . 210-N at completely opaque. The embodiment in FIG. 3 uses a semi-transparent level for both shaded region 208-1 . . . 208-N and outline 210-1 . . .210-N. The embodiment in FIG. 4 sets the transparency level for shaded region 208-1 . . . 208-N to completely transparent and the transparency level of outline 210-1 . . . 210-N to completely opaque. In some embodiments, the transparency level of shaded region 208-1 . . . 208-N and the transparency level of outline 210-1 . . . 210-N are independently adjustable. In other embodiments, the transparency level of shaded region 208-1 . . . 208-N and the transparency level of outline 210-1 . . . 210-N are mutually adjustable. Additionally, in other embodiments, the color of shaded region 208-1 . . . 208-N and the color of outline 210-1 . . . 210-N are adjustable across the full color spectrum. In some embodiments, the color of shaded region 208-1 . . . 208-N and the color of outline 210-1 . . . 210-N are independently adjustable. In other embodiments, the color of shaded region 208-1 . . . 208-N and the color of outline 210-1 . . . 210-N are mutually adjustable.

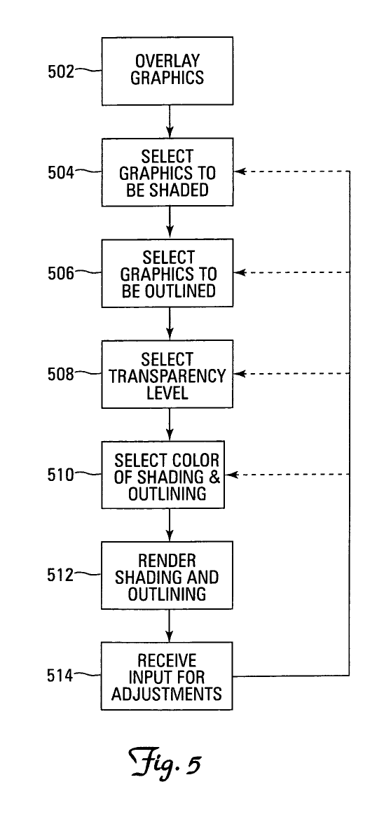

FIG. 5 is a flow chart showing a method of improving the readability of overlaid graphics according to one embodiment of the present invention. Instructions for carrying out the various methods, process tasks, calculations, control functions, and the generation of display signals and other data used in the operation of the display system are implemented in software programs, firmware or computer readable instructions. These instructions are typically stored on any appropriate medium used for storage of computer readable instructions such as floppy disks, conventional hard disks, CD-ROM, flash memory ROM, nonvolatile ROM, RAM, and other like medium.

The method begins at 502 with graphics overlaid on the same display. At 504, the graphics which are to be shaded with a shaded region are selected. The graphics which are shaded have a shaded region behind the graphics as shown in FIGS. 2-4. In some embodiments, this selection is accomplished through manual selection by a user. In other embodiments, the selection may be preset to a default value. At 506, the graphics which are to be outlined are selected. The graphics which are outlined have an outline around the graphic and shaded region, if applicable, as shown in FIGS. 2-4. The outline substantially surrounds the graphic and shaded region, if applicable. In some embodiments, the graphics which are outlined are the same as the graphics which are shaded. In other embodiments, the graphics which are outlined are not the same as the graphics which are shaded. In yet other embodiments, some of the graphics which are outlined are the same as the graphics which are shaded while others are not. In some embodiments, the selection is made manually by a user in real-time. In other embodiments, the selection is set to a default value.

At 508, the transparency level for the outlines and shaded regions is selected. The level of transparency in some embodiments ranges from completely transparent to completely opaque. In some embodiments, the level of transparency selected for the outlines is mutually selected with the transparency level of the shaded regions. In other embodiments, the transparency level of the outlines is selected separately from the transparency level of the shaded regions. In yet other embodiments, the transparency level for each outline and each shaded region is independently selected and adjusted. The transparency level, in some embodiments, is manually selected and adjusted by a user. In other embodiments, the transparency level is set to a default value.

At 510, the color of the outlines and shaded regions is selected. The color range available in some embodiments is the full visible color spectrum. In other embodiments, a limited color range is used. For example, when the display itself has limited color capabilities or when there is a need to conserve resources, embodiments using a limited color range are appropriate. In some embodiments, the color for each outline and each shaded region is independently selected and adjusted. The color, in some embodiments, is manually selected and adjusted by a user. The colors selected for the outlines and the shaded regions are typically different.

At 512, the shaded regions and outlines are rendered for the selected graphics. In some embodiments, the shaded regions and outlines will only be rendered when a user decides to render them. In other embodiments, the shaded regions and outlines are rendered automatically whenever the selected graphics are displayed. At 514, input is received to determine if adjustments are necessary. In some embodiments, this input and corresponding adjustments are manually entered by a user. The adjustments include adjustments to the selection of graphics to be shaded, the selection of graphics to be outlined, the transparency levels, and the color of the shaded regions and outlines. In some embodiments, all of the above mentioned selections are adjusted when necessary. In other embodiments, only certain selections are adjustable. In yet other embodiments, no input is received and none of the selections are adjustable.

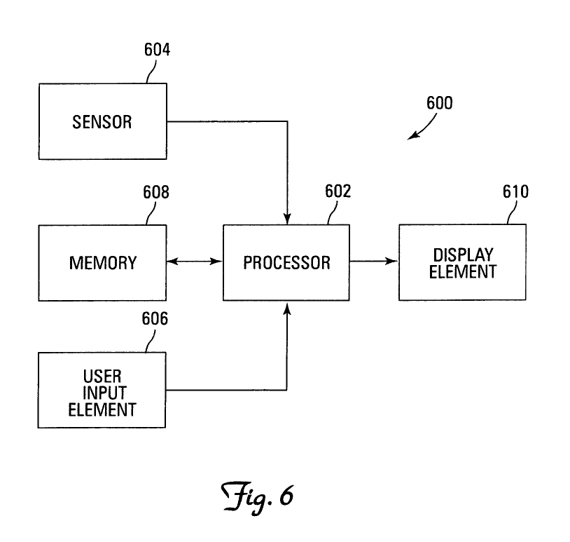

FIG. 6 is a block diagram of a graphical display system according to one embodiment of the present invention. In FIG. 6, an exemplary graphical display system 600 includes processor 602 configured to provide data for display to display element 610. One or more data sources are coupled to processor 602. These data sources include, but are not limited to, sensors 604, user input element 606 and memory 608. In some embodiments, one or more of these data sources are omitted. Sensors 604 are typically used to provide data to processor 602 for display on display element 610 and for use by processor 602 in determining what graphics to display. For example, in some embodiments, sensors 604 provide data regarding temperature, altitude, location, etc. as well as photographs and digital images for display on display element 610. In other embodiments, processor 602 uses data received from sensors 604, such as location, speed, etc., to determine the graphics to display, such as which terrain, street, airport, etc. In yet other embodiments, sensors 604 are used to receive data to determine the appropriate transparency level and color of the shaded regions and outlines as discussed above.

User input element 606 includes, but is not limited to, keyboards, electronic mice, touch screens, microphones, etc. In some embodiments, user input element 606 comprises more than one type of input element. In other embodiments, display system 600 does not include user input element 606. User input element 606 is used to provide user feedback to display system 600. Such feedback includes, but is not limited to, user selection of graphics to be outlined and shaded, user selection of transparency levels and user selection of outline and shading color.

Memory 608 includes any type of suitable medium such as floppy disks, conventional hard disks, CD-ROM, flash memory ROM, nonvolatile ROM, RAM, or other suitable medium. Processor 602 and memory 608 are coupled together allowing processor 602 to write to and store data in memory 608 as well as retrieve stored data from memory 608. In one embodiment, memory 608 stores data received by processor 602 from sensors 604 and user input element 606. In other embodiments, memory 608 temporarily stores data to be transmitted from processor 602 to display element 610. In other embodiments, memory 608 is used to store a database of graphics for retrieval by processor 602 and display on display element 610.

Processor 602 includes or interfaces with hardware components that support the graphics display system. By way of example and not by way of limitation, these hardware components include one or more microprocessors, memories, storage devices, interface cards, and other standard components known in the art. Additionally, processor 602 includes or functions with software programs, firmware or computer readable instructions for carrying out various methods, process tasks, calculations, control functions, and the generation of display signals and other data used in the operation of the display system. These instructions are typically stored on any appropriate medium used for storage of computer readable instructions such as floppy disks, conventional hard disks, CD-ROM, flash ROM, nonvolatile ROM, RAM, and other like medium. In some embodiments, these instructions are stored on memory 608.

Display element 610 includes any display element suitable for displaying the various symbols and information for the operation of embodiments of the present invention. There are many known display elements that are suitable for this task, such as various CRT, active matrix LCD and passive matrix LCD display systems. Processor 602 sends appropriate signals and data to display element 610. These signals and data instruct display element 610 which graphics to display and include instructions for displaying the shading and outlining necessary for the operation of embodiments of the present invention.

Although specific embodiments have been illustrated and described herein, it will be appreciated by those of ordinary skill in the art that any arrangement, which is calculated to achieve the same purpose, may be substituted for the specific embodiment shown. For example, although the specific embodiments illustrated are directed at aircraft, the method and apparatus may be used in various embodiments employing various types of displays, such as displays in space craft, automobiles, and hand held electronic devices, etc. This application is intended to cover any adaptations or variations of the present invention. Therefore, it is manifestly intended that this invention be limited only by the claims and the equivalents thereof.

What is claimed is:

1. A layered graphical display comprising:
a plurality of graphics, wherein one or more of said plurality of graphics is overlaid onto one or more other graphics of said plurality of graphics, and
a shaded region behind each of said one or more overlying graphics which distinguishes the one or more overlying graphics from the one or more other graphics.

2. The display of claim 1, further comprising:
an outline substantially surrounding each of said one or more overlying graphics and its respective shaded region.

3. The display of claim 2 wherein
said shaded regions and outlines have an adjustable transparency level.

4. The display of claim 3 wherein,
the transparency level of the outlines is adjustable independent of the transparency level of the shaded regions.

5. The display of claim 3 wherein,
the transparency level of the outlines and the transparency level of the shaded regions are mutually adjustable together.

6. The display of claim 3 wherein,
the transparency level of each of said shaded regions and each of said outlines is adjustable independent of the transparency level of other shaded regions and outlines.

7. The display of claim 2 wherein,
said shaded regions and outlines have an adjustable color.

8. The display of claim 7 wherein,
the adjustable color of the outlines is adjustable independent of the adjustable color of the shaded regions.

9. The display of claim 7 wherein,
the adjustable color of the outlines and the adjustable color of the shaded regions are mutually adjustable together.

10. The display of claim 7 wherein,
the adjustable color of each of said shaded regions and each of said outlines is adjustable independent of the adjustable color of other shaded regions and outlines.

11. A layered graphical display comprising,
means for displaying two or more graphics on a display element, wherein at least one of said two or more graphics is overlaid onto at least one other graphic of said two or more graphics,
means for calculating a shaded region for display on a display element,
means for calculating an outline for display on a display element,
means for displaying said calculated shaded region behind the at least one graphic overlaid onto at least one other graphic, said shaded region distinguishing the at least one overlaid graphic from the at least one other graphic, and
means for displaying said calculated outline around said shaded region and the at least one graphic overlaid onto at least one other graphic.

12. The display of claim 11 further comprising,
means for receiving input regarding the transparency level and color of said shaded region and outline, and
means for adjusting the transparency level and color of said shaded region and outline based on input received.

13. A method for improving the readability of graphics on a display comprising,
displaying a plurality of graphics on a display, wherein one or more graphics of said plurality of graphics is overlaid onto one or more other graphics of said plurality of graphics,
selecting which of the one or more overlying graphics to shade with a shaded region,
selecting which of the one or more overlying graphics to outline,
rendering the shaded region for the selected overlying graphics, and
rendering the outline for the selected overlying graphics.

14. The method of claim 13 wherein selecting which of the one or more overlying graphics to shade and which to outline further comprises,
manually selecting by a user which of the one or more overlying graphics to shade.

15. The method of claim 13 wherein rendering the shaded region and outline further comprises,
rendering the shaded region and outline only when decided by a user.

16. The method of claim 13 wherein rendering the shaded region and outline further comprises,
rendering the shaded region and outline whenever the selected one or more overlying graphics are rendered.

17. The method of claim 13 further comprising,
selecting the transparency level of the shaded regions and the transparency level of the outlines, and
selecting the color of the shaded regions and the color of the outlines.

18. A computer readable medium having computer-executable instructions for performing a method for improving the readability of graphics on a display, the method comprising:
selecting a first group of one or more graphics on a display to shade with a shaded region for each graphic selected,
selecting a second group of one or more graphics on a display to substantially surround with an outline for each graphic selected,
selecting a transparency level and a color for the one or more shaded regions,
selecting a transparency level and a color for the one or more outlines,
rendering the shaded region with the selected transparency level and color for each graphic in the first group, and
rendering the outline with the selected transparency level and color for each graphic in the second group.

19. The computer readable medium of claim 18, wherein the method further comprises,
receiving input for making adjustments to the one or more shaded regions and the one or more outlines.

20. The computer readable medium of claim 19, wherein making adjustments further comprises,
adjusting the transparency level of the one or more shaded regions and the one or more outlines.

21. The computer readable medium of claim 19, wherein making adjustments further comprises,
adjusting the color of the one or more shaded regions and the one or more outlines.

22. The computer readable medium of claim 19, wherein making adjustments further comprises,
adjusting the selection of the first group of one or more graphics, and
adjusting the selection of the second group of one or more graphics.

23. The computer readable medium of claim 19, wherein receiving input further comprises,
receiving input from a user.

24. A layered graphical display system, comprising:
a display element for graphical display of two or more graphics,
memory for storing instructions and graphical data, and
one or more processors for retrieving and processing instructions and graphical data from said memory and transmitting instructions and graphical data to said display element,
wherein the display element displays, based on the instructions and data transmitted from the one or more processors, two or more graphics with at least one graphic overlying another graphic, the overlying graphic having a shaded region behind the graphic and an outline surrounding the shaded region and graphic.

25. The layered graphical display system of claim 24, further comprising:
one or more sensors for receiving data to be processed by the one or more processors and displayed on the display element

26. The layered graphical display system of claim 24, further comprising:
one or more user input elements for transmitting user feedback to the one or more processors, wherein the user feedback is used by the one or more processors to adjust a transparency level and color of the shaded region and outline.
